(19) United States
(12) Patent Application Publication
(10) Pub. No.: US 2012/0240907 A1
(43) Pub. Date: Sep. 27, 2012

(54) STRATIFIED SCAVENGING TWO-CYCLE ENGINE AND CARBURETOR

(75) Inventors: Takeshi Watanabe, Saitama (JP); Ryou Ono, Sayama City (JP)

(73) Assignee: Husqvarna Zenoah Co., Ltd., Kawagoe-shi, Saitama (JP)

(21) Appl. No.: 13/503,110

(22) PCT Filed: Oct. 21, 2009
(86) PCT No.: PCT/JP2009/068126

§ 371 Date: Jun. 12, 2012

(51) Int. Cl. F02B 43/00; F02M 15/06

(52) U.S. Cl. 123/527

(57) ABSTRACT

A stratified scavenging two-cycle engine (10) comprising an engine body (11), a carburetor (12) equipped with a pivotable rotary valve (22) for switching between opening and closing of a single intake path, and an insulator (13) having heat insulating performance. The rotary valve (22) of the carburetor (12) is provided with a fuel injecting nozzle opening (26) open downward. The nozzle opening (26) is provided with a guide section (26A) by which fuel from the nozzle opening (26) is guided to a position corresponding to a position upstream in a mixed gas path (27).

### FIELD OF THE INVENTION

The present invention relates to a stratified scavenging two-cycle engine and a carburetor.

### BACKGROUND OF THE INVENTION

Traditionally, regarding carburetors for a stratified scavenging two-cycle engine, a carburetor in which a throttle valve is adopted as a rotary valve is known (for example, Patent Document 1). In the carburetor, a mixed gas path for generating mixed gas of air and fuel as well as an air path for passing leading air (pure air) for stratified scavenging are provided, with a cylindrical rotary valve arranged penetrating these paths. The rotary valve comprises a communication hole corresponding to the mixed gas path as well as a communication hole corresponding to the air path and switches opening and closing of each path by rotating the rotary valve such that each communication hole is caused to emerge or be hidden in each communication path.

Furthermore, as shown in FIG. 11, in the rotary valve, a needle 1 is penetrated along the rotational shaft center from one end thereof such that the tip of the needle 1 reaches a communication hole corresponding to the mixed gas path. On the other hand, from the side opposite the needle 1, a pipe-shaped nozzle for fuel 2 reaches the communication hole and the tip of the needle 1 is inserted from the tip of the nozzle for fuel 2. As described, the needle 1 and the nozzle for fuel 2 consist of a needle valve and the needle 1 shifts in the axial direction along with the rotation of the rotary valve to open and close a nozzle opening 3 provided with the nozzle for fuel 2. It should be noted that in FIG. 11, the flow of air is illustrated with an outlined arrow while the fuel is illustrated in misty form, respectively.

### PRIOR TECHNICAL DOCUMENT

### Patent Document

Patent Document 1: Japanese Unexamined Patent Application Publication No. 2008-69767

### OUTLINE OF THE INVENTION

### Problem to be Solved by the Invention

However, because the mixed gas path and the air path are separately provided for a carburetor, there is a problem in that the size of the carburetor is increased to accommodate the presence of two paths.

Furthermore, a proposal has been made to ensure separation of the mixed gas and leading air by dividing one intake path into a mixed gas path and an air path using a dividing plate while downsizing the carburetor; however, the throttle valve used in such a proposal is a butterfly valve, making the application difficult for structural reasons with respect to the rotary valve.

The purpose of the present invention is to provide a stratified scavenging two-cycle engine and a carburetor for said engine, capable of separating and supplying mixed gas and leading air without fail even in the case of using a small size carburetor comprising one intake path.

### Means of Solving the Problem

The stratified scavenging two-cycle engine in the present invention is a stratified scavenging two-cycle engine comprising: an engine body provided with an intake port through which mixed gas flows in and an air port through which leading air flows in, a carburetor for generating said mixed gas and leading air in the intake path, provided with a pivotable rotary valve for switching the opening and closing of one intake path, and an insulator arranged between said engine body and carburetor, provided with a mixed gas path for circulating said mixed gas and an air path for circulating said leading air, wherein a nozzle opening for ejecting fuel opened outward from a rotary shaft center side is provided for the rotary valve, and a guide section by which fuel from the nozzle opening is guided to a position corresponding to a position upstream in the mixed gas path among the mixed gas path and the air path is provided for the nozzle opening.

In the stratified scavenging two-cycle engine in the present invention, the insulator is provided with a partitioning section for partitioning the inside into the mixed gas path and the air path, while an extended projection provided integrally upstream of the partitioning section and extendedly projected in the intake path of the carburetor is ideally fit in the intake path.

In the stratified scavenging two-cycle engine of the present invention, the rotary shaft center of the rotary valve and the shaft line of a cylinder of the engine body may perpendicularly be crossed or may also be parallel.

Furthermore, the carburetor in the present invention is a carburetor comprising a body that includes one intake path and a pivotable rotary valve for switching the opening and closing of the intake path, wherein the rotary valve is provided with a nozzle opening for ejecting fuel outward from the rotary shaft center side and the nozzle opening is provided with a guide section by which fuel from the nozzle opening is guided to a prescribed position on the outward side.

In the carburetor of the present invention, the guide section is preferably formed into a cylindrical shape.

### Effects of the Invention

According to the stratified scavenging two-cycle engine and the carburetor used for said engine, because a guide section capable of guiding fuel to a position corresponding to a position upstream in a mixed gas path is provided at the nozzle opening of the carburetor, the fuel ejected from the nozzle opening may be favorably ejected upstream in the mixed gas path of an insulator by the guide section. Therefore, without mixing mixed gas containing the ejected fuel into an air path for leading air, said mixed gas is sucked straight into the engine body side through the mixed gas path ensuring separation and supplying of the mixed gas and leading air even when using a small size carburetor in which only one intake path is provided therein, making it possible to achieve the purpose of the present invention.

In the present invention, in case of providing an extended projection for the insulator, partitioning into the mixed gas path and the air path is possible from a position closer to the rotary valve, making it difficult for the mixed gas to flow into the air path side.

In the present invention, in case a rotary shaft center of the rotary valve and a shaft line of a cylinder are perpendicularly crossed, because it is thought that a cylinder is normally arranged when a shaft line is in an upright state, in case of a rotary valve with its rotary shaft center perpendicularly crossing the shaft line of the cylinder, the nozzle opening can be made downward allowing efficient suction of fuel onto the mixed gas path side by promptly ejecting said fuel downward using its own weight to improve output while ensuring separation from the air. Moreover, on the engine body side, because an intake port and an air port are provided in a vertical positional relationship, each path within the insulator may be formed into a straightforward form, allowing a reduction in path resistance and preventing fuel from stagnantly remaining.

In the present invention, if the rotary shaft center of the rotary valve and the shaft line of the cylinder are parallel, although the internal form of each path of the insulator becomes slightly complicated, it is possible to easily design the layout, etc. by following the mounting structure or layout of a carburetor in a normal two-cycle engine which is not a stratified scavenging type.

In the present invention, in case the guide section is cylindrically formed, dispersion of fuel output from the nozzle opening is suppressed by the guide section, ensuring that the fuel is ejected upstream without fail in the mixed gas path of the insulator.

### BRIEF DESCRIPTION OF THE DRAWINGS

FIG. 1 This is a cross-section drawing showing a two-cycle engine pertaining to Embodiment 1 of the present invention.

FIG. 2 This is a cross-section drawing showing the main section of a carburetor used for the engine in Embodiment 1.

FIG. 3 This is an oblique view showing the main section of a carburetor used for the engine in Embodiment 1.

FIG. 4 This is a cross-section drawing of a line IV-IV and is a cross-section drawing indicating the main part of the carburetor in Embodiment 1 from the upstream side.

FIG. 5 This is a front view of an insulator used for the engine in Embodiment 1.

FIG. 6 This is a cross-section drawing showing a two-cycle engine pertaining to Embodiment 2 of the present invention.

FIG. 7 This is a cross-section drawing showing the main section of a carburetor used for the engine in Embodiment 2.

FIG. 8 This is a cross-section drawing of a line VIII-VIII and is a cross-section drawing indicating the main part of the carburetor in Embodiment 2 from the upstream side.

FIG. 9 This is a front view of an insulator used for the engine in Embodiment 2.

FIG. 10 This is a cross-section drawing showing a modification example of the present invention.

FIG. 11 This is an oblique view describing the background technology.

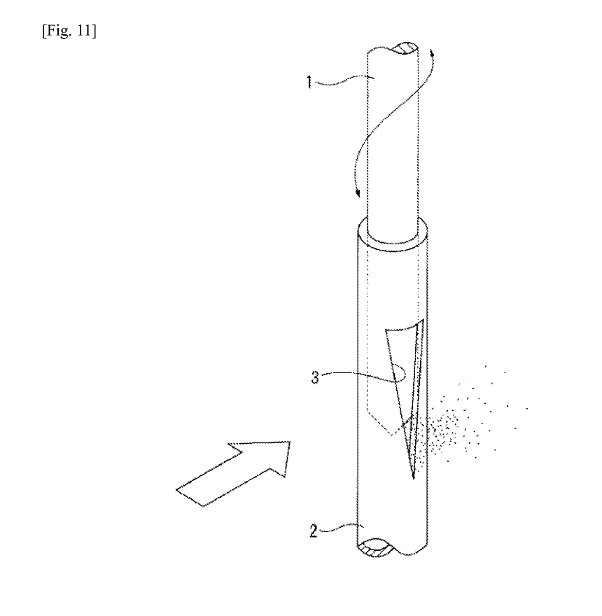

### EMBODIMENT TO IMPLEMENT THE INVENTION

### Embodiment 1

Hereinafter, a two-cycle engine (from hereon, referred to as an engine) 10 pertaining to Embodiment 1 of the present invention is described.

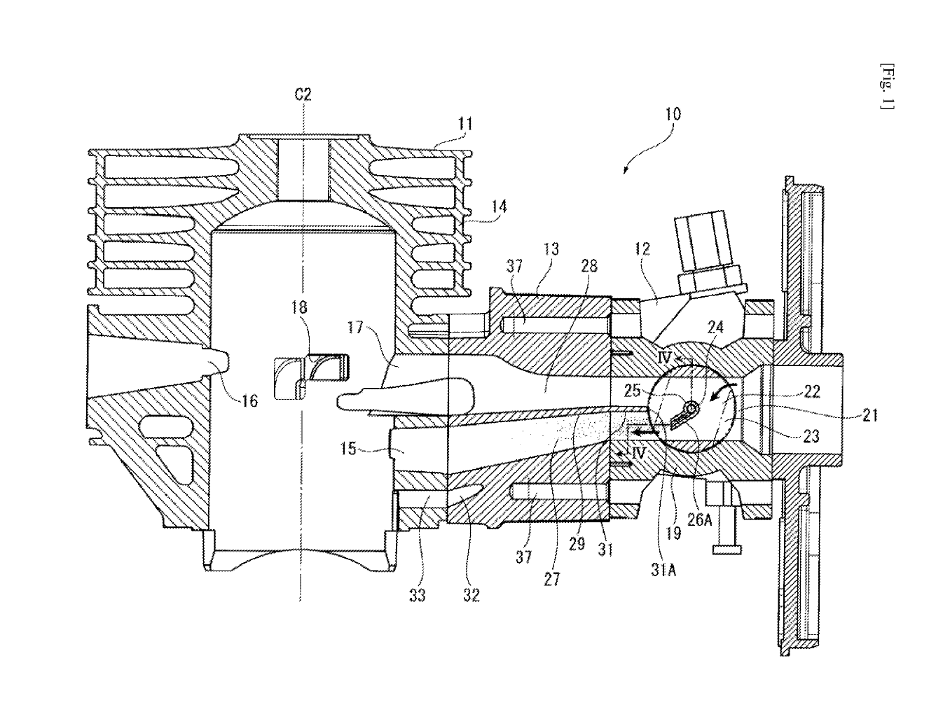

In FIG. 1, the engine 10 is a stratified scavenging two-cycle engine of a piston valve type and is configured comprising an engine body 11, a carburetor 12 for supplying mixed gas and leading air to the engine body 11, and an insulator 13 arranged between the engine body 11 and the carburetor 12 for blocking heat from the engine body 11 to the carburetor 12.

In the engine body 11, in FIG. 1, only a cylinder 14 is illustrated, with a crank case as well as a piston omitted from the illustration. In the present embodiment, which is a stratified scavenging two-cycle engine of a piston valve type, in addition to an intake port 15 and an exhaust port 16, an air port 17 for leading air is provided in the upper part of the intake port 15 for the cylinder 14.

The air port 17 is closed for communication with respect to an air communication path provided at the outer peripheral surface of a piston. Furthermore, the air communication path of the piston is closed for communication with respect to a scavenging port 18 provided with the cylinder 14. These communicating and closing switching operations are performed by reciprocating movements of the piston. As described, in a piston valve type, a piston functions as a valve for introducing leading air and the leading air is transported into the scavenging port 18 via the air port 17 through the air communication path on the outer periphery of the piston at the timing when mixed gas is guided into the crack case.

The carburetor 12 is traditionally used for a normal two-cycle engine instead of a stratified scavenging two-cycle engine, with one intake path 21 provided in a body 19. Furthermore, the body 19 is provided with a pivotable rotary valve 22 penetrating an intake path 21. A communication hole 23 is provided with the rotary valve 22 for communication between the upstream and the downstream of the intake path 21, switching opening and closing of the intake path 21 via the communication hole 23 according to the rotating position of the rotary valve 22. It should be noted that FIG. 1 shows a state in which the rotary valve 22 is completely open.

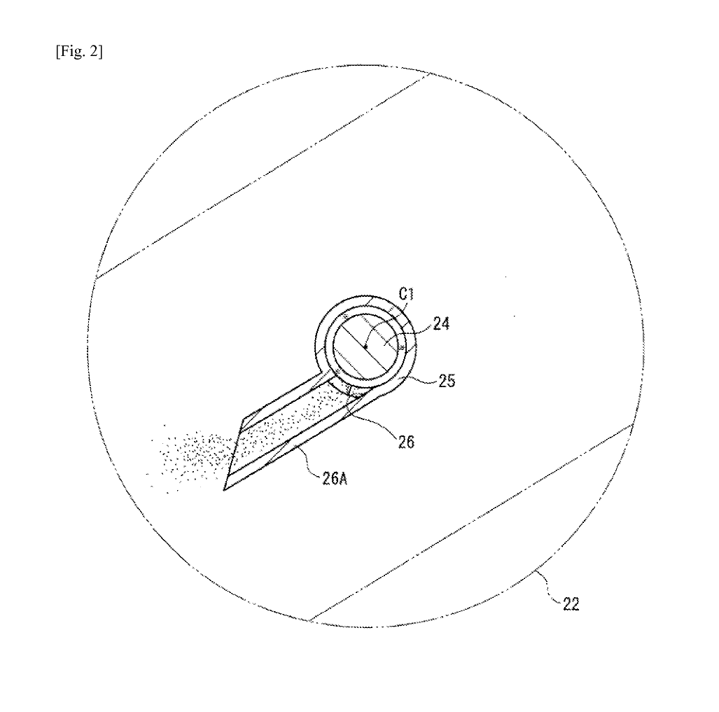

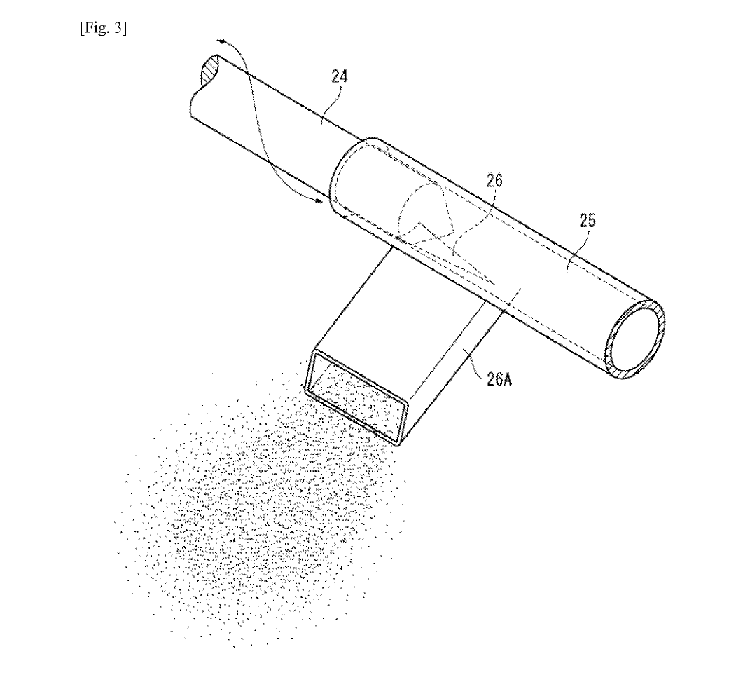

In this event, the carburetor 23 is arranged in a direction into which a rotary shaft center C1 of the rotary valve 22 perpendicularly crosses a shaft line C2 of the cylinder 14. A purge pump, etc. not illustrated but provided in the carburetor 12 ends up being in a side position with respect to the cylinder 14. In an arranged state facing such a direction, a needle 24 or a nozzle for fuel 25 are shown as a cross-section along the radial direction. The needle 24 and the nozzle for fuel 25 in the state of FIG. 1 are enlarged and shown in FIG. 2 and FIG. 3.

In FIGS. 1 through 3, a nozzle opening 26 provided with the nozzle for fuel 25 is opened downward in the figure. That is, fuel to be withdrawn from the nozzle opening 26 is output in a direction perpendicularly crossing with respect to the direction of suction flow from the rotary shaft center C1 side, specifically, downward in the figure within the communication hole 23 of the rotary valve 22.

A guide section 26A internally accommodating the nozzle opening 26 is provided with the nozzle for fuel 25. The guide section 26A is cylindrically formed and the tip end thereof opens to a position corresponding to a position upstream in a mixed gas path 27. Therefore, fuel output from the nozzle opening 26 is ejected to the position corresponding to a position upstream in the mixed gas path 27 to be described later by the guide section 26A provided with the nozzle opening 26. Moreover, the length of said guide section 26A is set long within a range without interfering with the rotation of the rotary valve 22, ensuring the fuel is guided without fail.

The fuel ejected from the guide section 26A is generated as mixed gas by mixing with air and the mixed gas is sucked toward the intake port 15 of the cylinder 14. On the other hand, because the fuel is not ejected to the upper side in the communication hole 23, air passing the upper side thereof is generated as leading air without containing fuel and is sucked into the air port 17 of the cylinder 14.

It should be noted in FIG. 1, the rotary valve 22 indicated by a dashed two-dotted line is at a position in which the engine 10 is in an idling state. Air passing through the rotary valve 22 flows into the communication hole 23 from the upper side of the intake path 21, descends within the communication hole 23, and flows out from the lower side of the intake path 21. Therefore, the direction of air descending in the communication hole 23 is approximately the same as the direction of the fuel being guided by the guide section 26A, as shown by an arrow in FIG. 1.

In FIG. 1, the insulator 13 is made from synthetic resin having heat insulating performance comprising a mixed gas path 27 on the lower side communicating with the intake port 15 of the cylinder 14 and an air path 28 on the upper side communicating with the air port 17 respectively on the downstream side. The upstream side of the mixed gas path 27 openly communicates corresponding to the lower side of the intake path 21 of the carburetor 12, while the upstream side of the air path 28 openly communicates corresponding to the upper side of the intake path 21.

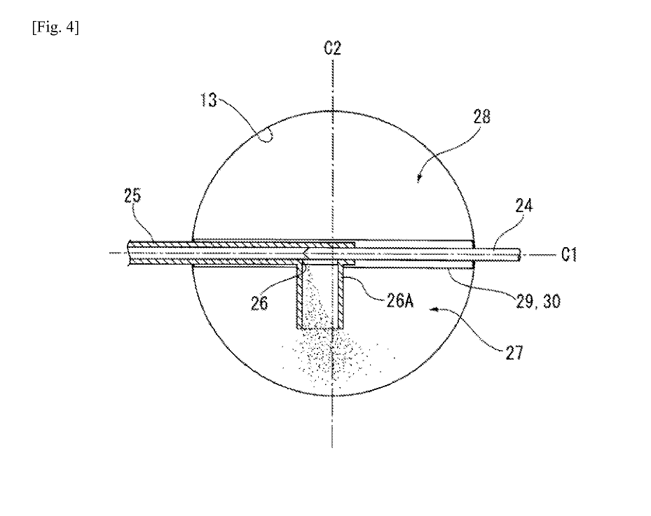

That is, as shown in FIG. 4, by enlarging the positional relationship of each path 27 and 28 of the insulator 13 and the nozzle opening 26, fuel guided by the guide section 26A is ejected to a position corresponding to a position upstream in the mixed gas path 27 among each of the paths 27 and 28. Therefore, mixed gas generated on the lower side within the communication hole 23 of the rotary valve 22 flows straight into the intake port 15 through the mixed gas path 27 on the lower side, while leading air generated on the upper side within the communication hole 23 flows straight into the air port 17 through the air path 28 on the upper side.

Each of the paths 27 and 28 within the insulator 13 are partitioned vertically by a partitioning section 29. The partitioning section 29 is formed into a plate shape by a flat face. The upstream side of the partitioning section 29 is provided with an extended projection 31 extendedly projecting in the intake path 21 of the carburetor 12 to the rotary valve 22. A tip end rim 31A of the extended projection 31 is parallel to a rotary shaft center C1 of the rotary valve 22 and also positioned at the same height in the figure. The connecting portion of the partitioning section 29 and the extended projection 31 is the same.

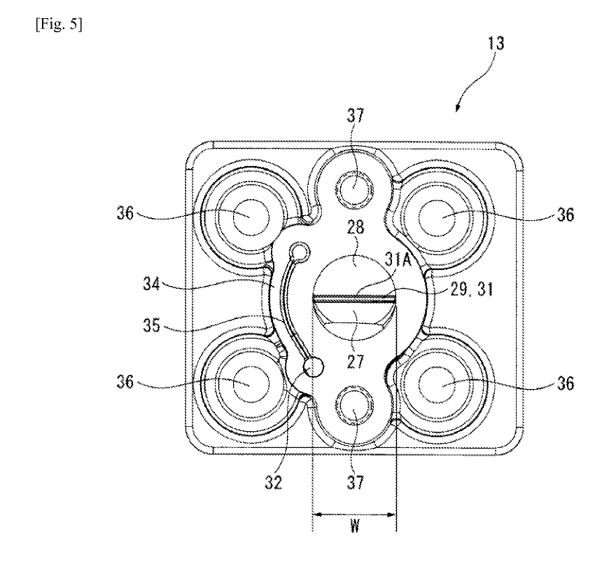

As shown in FIG. 5, the extended projection 31 is formed into a flat plate shape with the width W formed to be the same as the internal diameter of the intake path 21. Due to the extended projection 31, a portion on the downstream side within the intake path 21 is divided vertically into a mixed gas side and a leading air side without leaving any gaps to prevent mixed gas from flowing into the air path 28 side of the insulator 13.

Herein, the width W of the extended projection 31 may be made slightly larger than the internal diameter of the intake path 21 such that both ends widthwise of the extended projection 31 engage with a notch corresponding to inside the intake path 21 and, in such a case, the position of the extended projection 31 within the intake path 21 may be determined with greater assurance.

In FIG. 5, the insulator 13 is provided with a negative pressure transmission path 32 for transmitting negative pressure on the engine body 11 side to the carburetor 12 side and one end thereof communicates with a negative pressure output hole 33 (FIG. 1) of the cylinder 14 while the other end communicates with a negative pressure input hole of the carburetor 12 omitted from the illustration via a communication groove 35 provided on a carburetor mounting face 34. The negative pressure guided to the carburetor 12 is used to operate a diaphragm, etc. that functions as a fuel pump in the carburetor 12.

Furthermore, insertion holes 36 at the four corners of the insulator 13 are holes for inserting bolts which are used to secure the insulator 13 to the cylinder 14, and a vertical pair of screw holes 37 are holes for bolts to be screwed in order to secure the carburetor 12 to the insulator 13.

As described thus far, according to the present embodiment, the rotary shaft center C1 of the rotary valve 22 of the carburetor 12 perpendicularly crosses the shaft line C2 of the cylinder 14 and, in the communication hole 23 of the rotary valve 22, the nozzle opening 26 is opened downward corresponding to the intake port 15 on the lower side. The tip of the guide section 26A provided with the nozzle opening 26 opened at a position corresponding to a position upstream in the mixed gas path 27.

For this reason, the fuel from the nozzle opening 26 is guided to the position corresponding to a position upstream in the mixed gas path 27 by the guide section 26A, and may be transported without fail straight to the intake port 15 through the mixed gas path 27 on the lower side preventing the mixed gas from flowing into the air path 28 side. Therefore, as carburetor 12, a small one comprising only one intake path 21 may be used, allowing the engine 10 to be downsized.

Furthermore, when the engine 10 is in an idling state, because the air passing through the rotary valve 22 is approximately the same direction as the direction of the fuel guided by the guide section 26A, due to the ejector effect of air passing around the guide section 26A, the fuel may efficiently be withdrawn from the guide section 26A, making it possible to stabilize the number of engine rotations by stably supplying fuel even in an idling state with little air flow.

Moreover, in an idling state, because the downstream side of the communication hole 23 provided with the rotary valve 22 is open on the lower side of the intake path 21, mixed gas flows onto the mixed gas path 27 side with greater assurance. For this reason, the mixed gas may be transported without fail straight to the intake port 15 through the mixed gas path 27 on the lower side without allowing it to flow into the air path 28 side.

### Embodiment 2

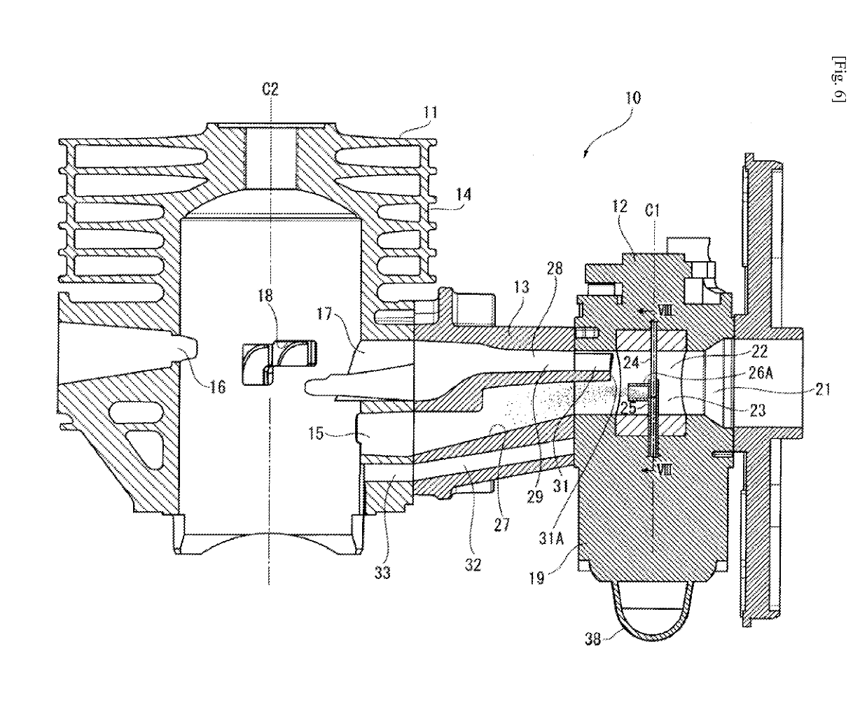

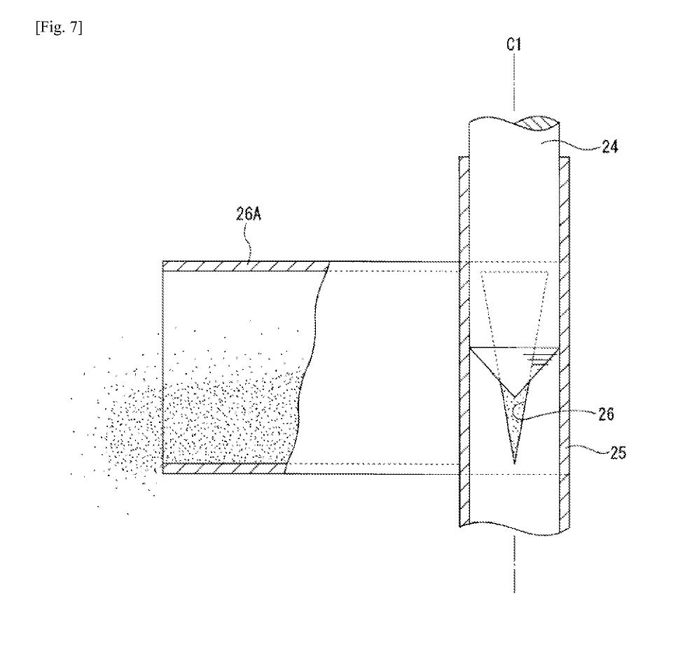

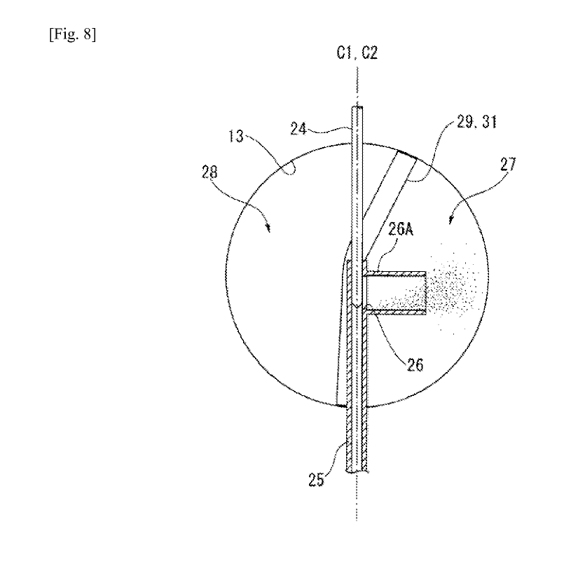

The engine 10 pertaining to Embodiment 2 of the present invention is shown in FIG. 6 and FIG. 7. In the present embodiment, the carburetor 12 is arranged such that the rotary shaft center C1 of the rotary valve 22 becomes parallel to the shaft line C2 of the cylinder 14. Therefore, as shown in the enlarged drawing in FIG. 8, the tip end of the guide section 26A opens at a position corresponding to a position upstream in the mixed gas path 27 in the communication hole 23 of the rotary valve 22, while mixed gas is generated from the ejected fuel guided by the guide section 26A and air passing the upstream in the mixed gas path 27. During this event, a purge pump 38 provided with the carburetor 12 comes to a position on the lower side.

On the other hand, leading air with no presence of fuel is generated in the upstream side of the air path 28. That is, in the present embodiment, the position at which the mixed gas is generated and the position at which the leading air is generated in the intake path 21 of the carburetor 12 are significantly different from Embodiment 1.

Therefore, the shape of the partitioning section 29 and the extended projection 31 in the insulator 13 to be used in the present embodiment is also significantly different from the previous Embodiment 1. That is, given the fact that the engine body 11 is the same both in the present embodiment and Embodiment 1 as well as the position of the intake port 15 and the position of the air port 17 in the cylinder 14, for the purpose of transporting the mixed gas or the leading air generated at different positions within the carburetor 12 to each of the ports 15 and 17, the partitioning section 29 and the extended projection 31 (a shape of each of the paths 27, 28) are formed into a shape corresponding to the generated position.

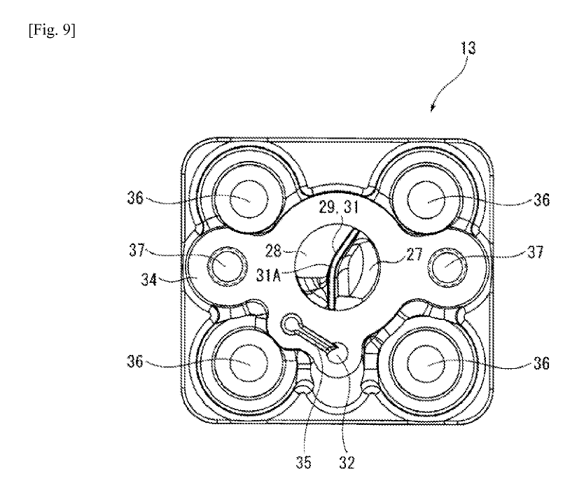

Specifically, with reference to FIG. 9, the partitioning section 29 and the extended projection 31 are formed into a curve approaching, in parallel, the rotary shaft center C1 on the carburetor 12 side heading upstream and also formed so as to vertically divide each of the paths 27 and 28 heading downstream by dividing each of the paths 27 and 28 into left and right. For this reason, in FIG. 8 and FIG. 9, while the mixed gas path 27 opens on the right side in the drawing, the air path 28 opens on the left side in the drawings.

Moreover, the guide member 26A opens at a position corresponding to a position upstream in the mixed gas path 27 on the right side. Therefore, likewise, the fuel from the nozzle opening 26 having been guided by the guide section 26A is ejected to a position corresponding to a position upstream in the mixed gas path 27.

As described, even if each of the paths 27 and 28 are twisted inside the insulator 13, as a result of guiding fuel onto the mixed gas path 27 side by the guide section 26A, the mixed gas is transported without fail to the intake port 15 through the mixed gas path 27 without flowing onto the air path 28 side, and the leading air is transported to the air port 17 through the air path 28. This is the same as in Embodiment 1 as a carburetor 12 to be used, making it possible to obtain the same action effect in the present embodiment as in Embodiment 1 and achieve the purpose of the present invention.

It should be noted that the present invention is not limited to each of the previous embodiments and modification examples within the scope in which the purpose of the present invention may be achieved are included in the present invention.

For example, the carburetor 12 in the previous Embodiment 1 is mounted such that the rotary shaft center C1 of the rotary vale 22 perpendicularly crosses the shaft line C2 of the cylinder 14 and the carburetor 12 in Embodiment 2 is mounted such that the rotary shaft center C1 of the rotary valve 22 comes to parallel the shaft line C2 of the cylinder 14; however, the relationship between the rotary shaft center C1 and the shaft line C2 is arbitrary and it is also possible to mount said carburetor so as to cross an angle other than 90°.

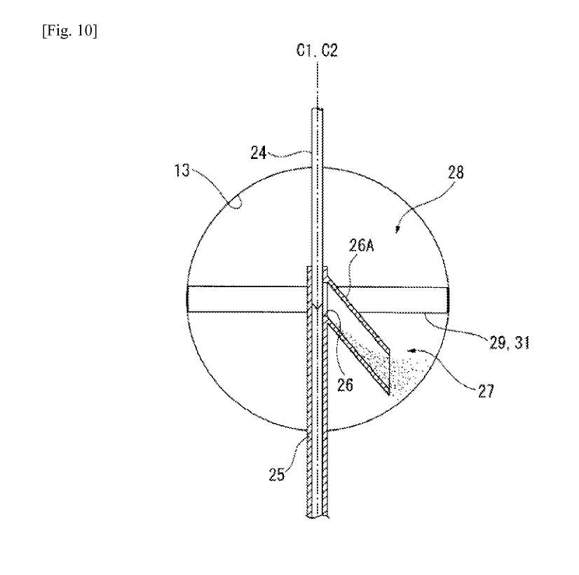

Moreover, as shown in FIG. 10, even if the rotary shaft center C1 and the shaft line C2 are caused to be in parallel, the partitioning section 29 or the extended projection 31 of the insulator 13 may also be provided so as to perpendicularly cross the rotary shaft center C1 and the shaft line C2. In such a case, even if the nozzle opening 26 and the partitioning section 29 or the extended projection 31 are positioned together in the center of the air path 21, by opening the guide section 26A toward the mixed gas path 27 side, fuel from the nozzle 26 may be guided to a position corresponding to a position upstream in the mixed gas path 27 to be ejected therefrom.

Therefore, the same action effect as in Embodiment 1 may be obtained to achieve the purpose of the present invention without vertically shifting the positional relationship of the nozzle opening 26 and the partitioning section 29 or the extended section 31. However, it is also possible to cause the fuel ejected from the guide section 26A to flow without fail into the mixed gas path 27 from the guide section 26A with greater assurance by vertically shifting the nozzle opening 26 and the partitioning section 29 or the extended section 31.

Furthermore, the guide section 26A was a cylindrical shape, but said guide section may also be a tongue-shape or a U-shaped cross-section, without being limited to the former as long as the fuel output from the nozzle opening 26 can be guided to a position corresponding to a position upstream in the mixed gas path 27.

### INDUSTRIAL APPLICABILITY

The present invention may favorably be applied to a piston valve-type or a lead-valve type stratified scavenging two-cycle engine.

### EXPLANATION OF THE SYMBOLS

10 . . . stratified scavenging two-cycle engine, 11 . . . engine body, 12 . . . carburetor, 13 . . . insulator, 14 . . . cylinder, 15 . . . intake port, 17 . . . air port, 19 . . . body, 21 . . . intake path, 22 . . . rotary valve, 26 . . . nozzle opening, 26A . . . guide section, 27 . . . mixed gas path, 28 . . . air path, 29 . . . partitioning section, 31 . . . extended projection, C1 . . . rotary shaft center, C2 . . . shaft line.

1. A stratified scavenging two-cycle engine comprising:
an engine body provided with an intake port through which mixed gas flows in and an air port through which leading air flows in,
a carburetor that is provided with a pivotable rotary valve for switching the opening and closing of one intake path and which generates said mixed gas and leading air in said intake path, and
an insulator that is provided with a mixed gas path for circulating said mixed gas and an air path for circulating said leading air and which is arranged between said engine body and carburetor, wherein
a nozzle opening opened outward for ejecting fuel from a rotary shaft center side is provided with said rotary valve, and
a guide section for guiding the fuel from the nozzle opening to a position corresponding to a position upstream in said for gas path is provided for said nozzle opening.

2. The stratified scavenging two-cycle engine according to claim 1, wherein said insulator is provided with a partitioning section for partitioning the inside thereof into said mixed gas path and said air path, and an extended projection provided integrally on the upstream side of said partitioning section extendedly projected into an intake path of said carburetor, and said extended projection fits into said intake path.

3. The stratified scavenging two-cycle engine according to claim 1, wherein a rotary shaft center of said rotary valve and a shaft line of a cylinder of said engine body are perpendicularly crossed.

4. The stratified scavenging two-cycle engine according to claim 1, wherein a rotary shaft center of said rotary valve and the shaft line of the cylinder of said engine body are in parallel.

5. A carburetor comprising a body including one intake path and a pivotable rotary valve for switching opening and closing of said intake path, wherein
said rotary valve is provided with a nozzle opening opened outward for ejecting fuel from the rotary shaft center side, and
said nozzle opening is provided with a guide section for guiding the fuel from the nozzle opening to a prescribed position on said outward side.

6. The carburetor according to claim 5, wherein said guide section is formed into a cylindrical shape.
